(19) United States
(12) Patent Application Publication
(10) Pub. No.: US 2005/0198402 A1
(43) Pub. Date: Sep. 8, 2005

(54) Server-client system and method for operating the same

(75) Inventors: Jong Hoon Chung, Kyungki-do (KR); Dae Sung Wang, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (JP)

(21) Appl. No.: 10/921,193

(22) Filed: Aug. 19, 2004

(30) Foreign Application Priority Data
Feb. 23, 2004 (KR) 2004-11919

(51) Int. Cl. G06F 15/16

(52) U.S. Cl. 709/250

(57) ABSTRACT

A server-client system and a method for operating the same are disclosed. A resolution server is provided to automatically store or update information regarding various resolutions of one or more client terminals connected to a wired/wireless network so that user interfaces appropriate respectively to the resolutions can be provided to the client terminals on the basis of the stored or updated resolution information. If the resolution information of any one of the client terminals connected to the wired/wireless network is automatically recognized, the appropriate user interface data is sent to the terminal on the basis of the recognized resolution information. Therefore, appropriate user interfaces can be provided respectively to client terminals having different resolutions according to manufacturers, models, functions, etc. thereof, thereby increasing convenience of users and reliability of the system.

### BACKGROUND OF THE INVENTION

1. Field of the Invention

The present invention relates to server-client systems, and more particularly to a server-client system and a method for operating the same, wherein a resolution server is provided to automatically store or update information regarding various resolutions of one or more client terminals such that user interfaces appropriate respectively to the resolutions are implemented in the client terminals on the basis of the stored or updated resolution information, respectively.

2. Description of the Related Art

FIG. 1 shows the configuration of a general server-client system.

A server 1 signifies a specific program which executes an entire network monitoring/controlling function, including controlling a printer connected to the same network N or managing a file connected thereto, and provides services enabling a connection between the network N and a different network through a public network or a mainframe such that hardware resources, such as a modem, a printer and other equipment, as well as software resources, such as data, a program, a file, etc., are shared therebetween, or a device equipped with such a specific program.

The server 1 provides the above services to a user (client) in response to a request therefrom. A system consisting of the server 1 and one or more client terminals H is typically called a server-client system.

Generally, in a small-scale network where the number of client terminals H is on the order of 5 to 20, it is possible for only one server to provide all the services. However, in a large-scale network, a plurality of servers must be arranged to provide all of the services. For example, a file server may act to manage files, a printer server may act to control a printer, and a communication server may act to communicate with an external network, such as the Internet. In this manner, the several servers have to play subdivided roles according to their functions.

Meanwhile, a server on the Internet refers to a computer that provides information, stored on a hard disk thereof in specific form, to the public. A general user gains access to the server using his/her computer (client terminal) and uses information provided from the server according to his/her intentions.

Accordingly, the server 1 may be a home server that mainly controls a wired/wireless home network constructed in a home, or a Web server that provides services for specific purposes over the Internet. In the specification, for the convenience of description and better understanding of the server-client system which is applicable in various ways, it will hereinafter be described for illustrative purposes that the server 1 is a Web server that provides services over a wireless network and the client terminal H is a wireless terminal that receives various data from the Web server.

Upon being accessed by the wireless terminal over the wireless network, the Web server sends a user interface to the terminal to enhance the convenience of a user of the terminal using the Web server. As a result, the user can use various contents provided by the Web server conveniently through the user interface sent to the terminal.

At this time, the terminal has different resolutions used or supported according to a manufacturer, model, functions, etc. thereof. The different resolutions may also be used according to the user's selections. For this reason, user interfaces appropriate respectively to the resolutions of the terminal are different.

In the conventional server-client system with the above-mentioned configuration, however, the home server in the home network or the Web server is adapted to send, to the terminal, a user interface developed to be appropriate to only a specific resolution due to a technical problem.

For this reason, provided that the terminal does not have the specific resolution, it will be subject to occurrence of a scroll bar on the screen thereof upon accessing the Web server through the user interface. Further, the user will have the inconvenience of having to operate a mouse or keyboard in order to do desired work.

Moreover, provided that the terminal has the specific resolution, but is not optimized thereto, a separate operation, such as the user's operation of manually converting the resolution of the terminal to the specific resolution for his/her convenience, will be disadvantageously required.

### SUMMARY OF THE INVENTION

Therefore, the present invention has been made in view of the above problems, and it is an object of the present invention to provide a server-client system and a method for operating the same, wherein a resolution server is provided to automatically store or update information regarding different resolutions of one or more client terminals so that user interfaces appropriate respectively to the resolutions can be sent to the client terminals on the basis of the stored or updated resolution information in such a way that they correspond one-to-one to the client terminals, thereby increasing convenience of users and reliability of the system.

In accordance with an aspect of the present invention, the above and other objects can be accomplished by the provision of a server-client system comprising: one or more client terminals having different resolutions and adapted for transmitting and receiving data over a wired/wireless network; a network server for sending user interface (UI) data appropriate respectively to the resolutions of the client terminals to the terminals over the network; and a resolution server for automatically storing information regarding the resolutions of the client terminals and sending the user interface data appropriate respectively to the resolutions of the client terminals to the terminals through the network server on the basis of the stored resolution information.

Preferably, the resolution server includes: a UI database for storing user interface data of different resolutions such that user interfaces appropriate respectively to the client terminals are implemented; and a microcomputer for sending the user interface data appropriate respectively to the resolutions of the client terminals to the network server on the basis of the resolution information of the terminals.

Preferably, the resolution server further includes a resolution recognizer for automatically recognizing a change in the resolution of each of the client terminals and updating the resolution information of each of the client terminals with information regarding the changed resolution.

The resolution server may further include a resolution database for storing the resolution information of the client terminals connected to the network.

In accordance with another aspect of the present invention, there is provided a method for operating a server-client system, comprising the steps of: a) connecting at least one client terminal to a network server over a wired/wireless network; b) recognizing information regarding a resolution of the client terminal and sending user interface data appropriate to the resolution of the client terminal to the terminal on the basis of the recognized resolution information; and c) implementing a user interface in the client terminal on the basis of the sent user interface data.

Preferably, the step b) includes the steps of: b-1), if the resolution of the client terminal is changed, recognizing the changed resolution; and b-2) sending user interface data appropriate to the changed resolution of the client terminal to the client terminal.

In a feature of the present invention, a resolution server is provided to automatically store or update information regarding different resolutions of one or more client terminals connected to a wired/wireless network so that user interfaces appropriate respectively to the resolutions can be sent to the client terminals on the basis of the stored or updated resolution information. Therefore, appropriate user interfaces can be provided respectively to client terminals having different resolutions according to manufacturers, models, functions, etc. thereof, thereby increasing convenience of users and reliability of the system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a general server-client system;

FIG. 2 is a schematic view of a server-client system according to the present invention;

FIG. 3 is a block diagram showing the configuration of a first embodiment of the server-client system according to the present invention;

FIG. 4 is a block diagram showing the configuration of a second embodiment of the server-client system according to the present invention; and

FIG. 5 is a flow chart illustrating the operation of the server-client system according to the present invention.

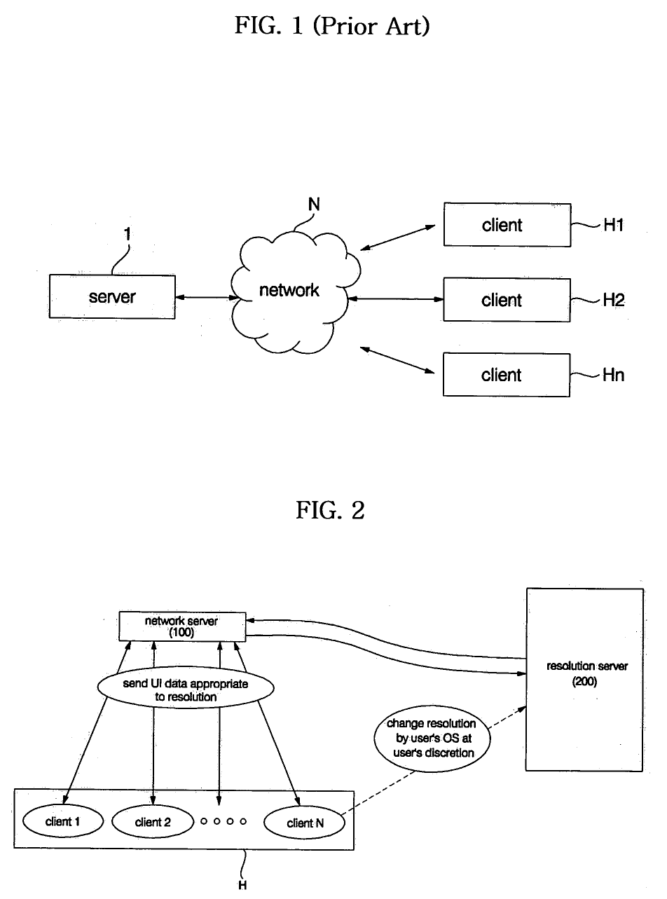

### DESCRIPTION OF THE PREFERRED EMBODIMENTS

Now, preferred embodiments of a server-client system and a method for operating the same according to the present invention will be described in detail with reference to the annexed drawings. In the drawings, the same or similar elements are denoted by the same reference numerals even though they are depicted in different drawings.

FIG. 2 is a schematic view of a server-client system according to the present invention.

As shown in FIG. 2, the server-client system according to the present invention comprises one or more client terminals H having different resolutions and adapted for transmitting and receiving data over a wired/wireless network, a network server 100 for transmitting and receiving data to/from the client terminals H over the network and sending user interface data appropriate respectively to the resolutions of the client terminals H to the terminals H over the network, and a resolution server 200 for automatically storing information regarding the resolutions of the client terminals H and sending the user interface data appropriate respectively to the resolutions of the client terminals H to the terminals H through the network server 100 on the basis of the stored resolution information.

Preferably, in the server-client system, the network server 100 is a general Web server and the client terminals H, connected to the server 100, are computers or personal digital assistants (PDAs).

Alternatively, the client terminals H may be home appliances and the network server 100 may be a home server that is connected with the home appliances over the network to transmit and receive data to/from the home appliances so as to control the operations of the appliances and monitor the states thereof. In this case, the server-client system according to the present invention can be implemented as a home network system or home appliance network system where a home server centrally controls one or more home appliances installed in a home or building.

The network, which interconnects the server 100 and client terminals H of the server-client system, can be a wired network using a specific cable, or a wireless network that transmits and receives radio frequency (RF) data over the air.

The client terminals H each may be electronic equipment, such as a computer, PDA or Web pad, for enabling a user to control a plurality of home appliances connected to the network in an integrated manner, or access a plurality of Web servers connected to the network to acquire specific information therefrom.

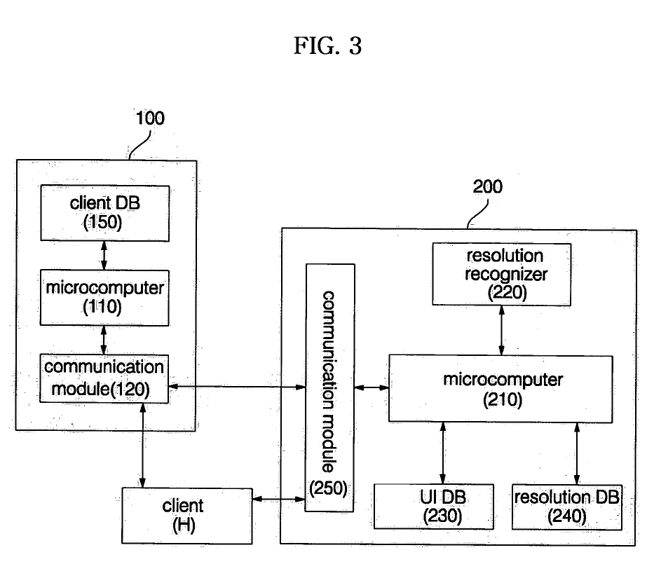

FIG. 3 is a block diagram showing the configuration of a first embodiment of the server-client system according to the present invention.

In the server-client system according to the first embodiment, the network server 100 includes a microcomputer 110 for receiving the user interface data sent from the resolution server 200 and sending the received data to the client terminals H, respectively, and a communication module 120 connected in common to the client terminals H and the resolution server 200 for format-converting data transmitted and received over the network so that it is readable.

The network server 100 further includes a client database (DB) 150 for storing product information and state information received from the client terminals H when the terminals H are newly connected to the network server 100 over the network.

The resolution server 200 includes a user interface (UI) DB 230 for storing user interface data of different resolutions such that user interfaces appropriate respectively to the client terminals H are implemented, a microcomputer 210 for sending the user interface data appropriate respectively to the resolutions of the client terminals H to the network server 100 on the basis of the resolution information of the terminals H, and a communication module 250 connected in common to the client terminals H and the network server 100 for format-converting data transmitted and received over the network so that it is readable.

The communication modules 120 and 250 of the network server 100 and resolution server 200 are of either an internal or external type. Since the network is a wired/wireless network as described above, the communication modules 120 and 250 are based on a corresponding communication protocol.

The resolution server 200 further includes a resolution recognizer 220 for automatically recognizing a change in the resolution of each of the client terminals H and updating the resolution information of each of the client terminals H with information regarding the changed resolution, and a resolution DB 240 for storing the resolution information of the client terminals H connected to the network.

The resolution DB 240 may include a buffer (not shown) for receiving and temporarily storing the changed resolution information of the client terminals H from the resolution recognizer 220.

The resolution recognizer 220 functions to automatically recognize a change in the resolution of each of the client terminals H and update the resolution information of each of the client terminals H with information regarding the changed resolution. At this time, the resolution recognizer 220 updates the resolution information stored in the resolution DB 240 with the changed resolution information.

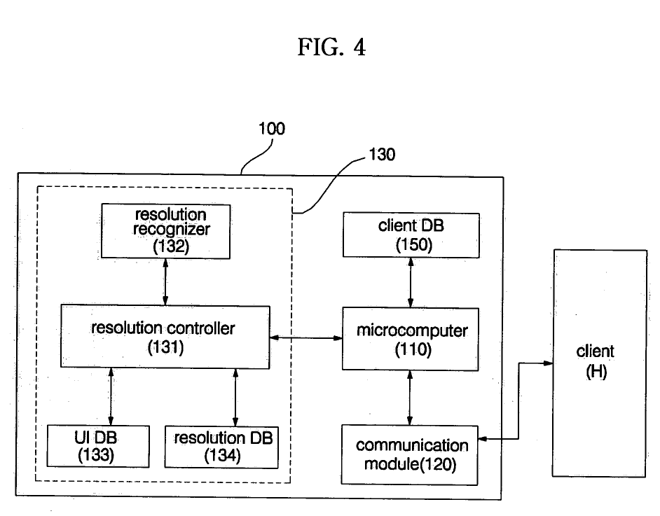

FIG. 4 is a block diagram showing the configuration of a second embodiment of the server-client system according to the present invention. The second embodiment is substantially the same in construction as the first embodiment, with the exception that the resolution server is included in the network server in the form of a module.

In other words, in the server-client system according to the second embodiment, the client terminals H have different resolutions and act to transmit and receive data over a wired/wireless network, and the network server 100 includes a resolution module 130 for automatically storing information regarding the resolutions of the client terminals H over the network and sending user interface data appropriate respectively to the resolutions of the client terminals H to the terminals H on the basis of the stored resolution information.

The resolution module 130 is similar in construction to the resolution server 200 of the first embodiment. That is, the resolution module 130 includes a UI DB 133 for storing user interface data of different resolutions such that user interfaces appropriate respectively to the client terminals H are implemented, and a resolution controller 131 for, if the resolution of each of the client terminals H is changed, sending user interface data corresponding to the changed resolution to the microcomputer 110.

The resolution module 130 further includes a resolution recognizer 132 for automatically recognizing a change in the resolution of each of the client terminals H and sending information regarding the changed resolution to the resolution controller 131, and a resolution DB 134 for storing the resolution information of the client terminals H connected to the network.

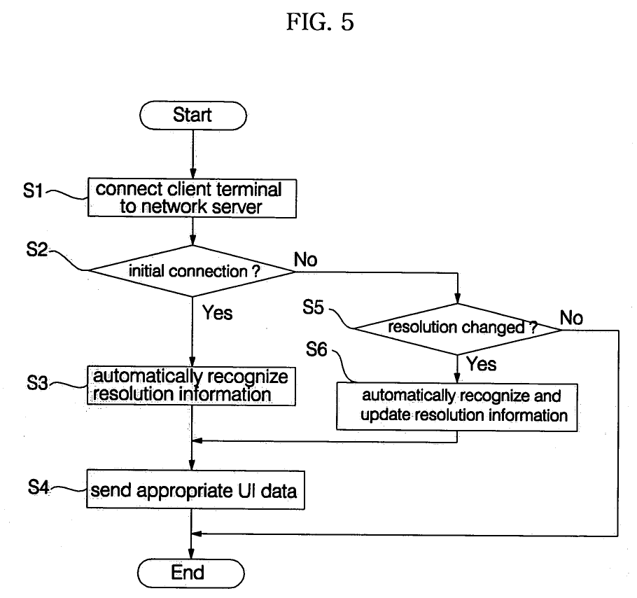

A detailed description will hereinafter be given of the operation of the server-client system with the above-stated construction according to the present invention with reference to FIG. 5.

FIG. 5 is a flow chart illustrating the operation of the server-client system according to the present invention.

First, at least one client terminal is connected to the network server over the wired/wireless network (S1).

In the case where the server-client system according to the present invention is applied as a home network system, a user of the home network system operates the network server as a home server to input a control command to the client terminal as a desired home appliance to be controlled, and the home server generates a control signal in response to the control command and sends it to the desired home appliance.

Upon being connected with the client terminal, the network server generates a control signal and sends it to the client terminal, which then sends product information and state information thereof back to the network server in response to the control signal (S2).

The network server then receives the product information and state information sent from the client terminal, extracts information regarding a resolution of the client terminal from the received state information and sends the extracted resolution information to the resolution server (S3), which then receives the sent resolution information and databases it in order.

The resolution server then extracts user interface data corresponding to the resolution information of the client terminal from among user interface data appropriate respectively to various resolutions, stored therein, and sends the extracted user interface data to the client terminal through the network server (S4).

A user interface is implemented in the client terminal on the basis of the user interface data sent from the resolution server, so that it can be used according to the intentions of a user of the client terminal.

Meanwhile, if the user of the client terminal changes the resolution of the client terminal during the system operation, then the resolution server recognizes the changed resolution (S5).

The resolution server then sends user interface data appropriate to the changed resolution of the client terminal to the network server, which in turn sends the user interface data to the client terminal.

The resolution server automatically updates the existing resolution information stored in the resolution DB with information regarding the changed resolution (S6).

As apparent from the above description, the present invention provides a server-client system and a method for operating the same, wherein a resolution server is provided to automatically store or update information regarding different resolutions of one or more client terminals so that user interfaces appropriate respectively to the resolutions can be sent to the client terminals on the basis of the stored or updated resolution information. Therefore, appropriate user interfaces can be provided respectively to client terminals having different resolutions according to manufacturers, models, functions, etc. thereof, thereby increasing convenience of users and reliability of the system.

Further, a resolution module may be implemented in a network server to function as the resolution server. In this case, the user interfaces corresponding respectively to the different resolutions can be implemented in the client terminals, respectively, without using a separate device, thereby increasing convenience of the users and facilitating the construction of the server-client system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present disclosure relates to subject matter contained in Korean Application No. 10-2004-0011919, filed on Feb. 23, 2004, the contents of which are herein expressly incorporated by reference in its entirety.

1. A server-client system comprising:
one or more client terminals having different resolutions and adapted for transmitting and receiving data over a wired/wireless network;
a network server for sending user interface (UI) data appropriate respectively to said resolutions of said client terminals to said terminals over said network; and
a resolution server for automatically storing information regarding said resolutions of said client terminals and sending said user interface data appropriate respectively to said resolutions of said client terminals to said terminals through said network server on the basis of the stored resolution information.

2. The server-client system as set forth in claim 1, wherein said resolution server includes:
a UI database for storing user interface data of different resolutions such that user interfaces appropriate respectively to said client terminals are implemented; and
a microcomputer for sending said user interface data appropriate respectively to said resolutions of said client terminals to said network server on the basis of said resolution information of said terminals.

3. The server-client system as set forth in claim 2, wherein said resolution server further includes a resolution recognizer for automatically recognizing a change in said resolution of each of said client terminals and updating said resolution information of each of said client terminals with information regarding the changed resolution.

4. The server-client system as set forth in claim 3, wherein said resolution server further includes a resolution database for storing said resolution information of said client terminals connected to said network.

5. The server-client system as set forth in claim 4, wherein said resolution database includes a buffer for receiving and temporarily storing the changed resolution information of said client terminals from said resolution recognizer.

6. The server-client system as set forth in claim 1, wherein said network server includes:
a client database for storing product information and state information received from said client terminals when said terminals are newly connected to said network server; and
a microcomputer for receiving said user interface data sent from said resolution server and sending the received data to said client terminals, respectively.

7. The server-client system as set forth in claim 6, wherein said microcomputer is adapted to, when said client terminals are newly connected to said network server, extract said resolution information of each of said client terminals from said state information received from each of said client terminals and send the extracted resolution information to said resolution server such that a user interface appropriate to each of said client terminals is implemented on the basis of the sent resolution information.

8. The server-client system as set forth in claim 1, wherein said network server and resolution server each include a communication module for format-converting data transmitted and received over said network so that it is readable.

9. A server-client system comprising:
one or more client terminals having different resolutions and adapted for transmitting and receiving data over a wired/wireless network; and
a network server for automatically storing information regarding said resolutions of said client terminals over said network and sending user interface data appropriate respectively to said resolutions of said client terminals to said terminals on the basis of the stored resolution information.

10. The server-client system as set forth in claim 9, wherein said network server includes:
a resolution module for storing or updating said resolution information of said client terminals and said user interface data appropriate respectively to said resolutions of said client terminals;
a microcomputer for receiving said user interface data from said resolution module and sending the received data to said client terminals, respectively; and
a communication module for format-converting data transmitted and received to/from said client terminals over said network so that it is readable.

11. The server-client system as set forth in claim 10, wherein said resolution module includes:
a UI database for storing user interface data of different resolutions such that user interfaces appropriate respectively to said client terminals are implemented; and
a resolution controller for, if said resolution of each of said client terminals is changed, sending user interface data corresponding to the changed resolution to said microcomputer.

12. The server-client system as set forth in claim 11, wherein said resolution module further includes a resolution recognizer for automatically recognizing a change in said resolution of each of said client terminals and sending information regarding the changed resolution to said resolution controller.

13. The server-client system as set forth in claim 12, wherein said resolution module further includes a resolution database for storing said resolution information of said client terminals connected to said network.

14. A method for operating a server-client system, comprising the steps of:
a) connecting at least one client terminal to a network server over a wired/wireless network;
b) recognizing information regarding a resolution of said client terminal and sending user interface data appropriate to said resolution of said client terminal to said terminal on the basis of the recognized resolution information; and
c) implementing a user interface in said client terminal on the basis of the sent user interface data.

15. The method as set forth in claim 14, wherein said step b) includes the step of, if said resolution information of said client terminal is automatically recognized, storing the recognized resolution information.

16. The method as set forth in claim 14, wherein said step b) includes the steps of:
b-1), if said resolution of said client terminal is changed, recognizing the changed resolution; and
b-2) sending user interface data appropriate to the changed resolution of said client terminal to said client terminal.

17. The method as set forth in claim 16, wherein said step b) further includes the step of:
b-3) updating existing resolution information stored in a database with information regarding the changed resolution recognized at said step b-1).
